(19) United States
(12) Patent Application Publication
(10) Pub. No.: US 2015/0048176 A1
(43) Pub. Date: Feb. 19, 2015

(54) APPARATUS FOR GENERATING MISTS AND FOAMS

(71) Applicant: Tyco Fire & Security GmbH, Neuhausen am Rheinfall (CH)

(72) Inventors: Colin JONES, Huntingdon (GB); James FRENCH, Huntingdon (GB)

(21) Appl. No.: 14/519,488

(22) Filed: Oct. 21, 2014

Related U.S. Application Data
(63) Continuation of application No. 13/881,701.
(60) Provisional application No. 61/419,674, filed on Dec. 3, 2010.

(30) Foreign Application Priority Data
Dec. 3, 2010 (GB) 1020539.1

(51) Int. Cl. B05B 7/00; B01F 3/04

(52) U.S. Cl. CPC B05B 7/0025; B01F 3/04446
USPC 239/8; 239/418

(57) ABSTRACT

An apparatus for generating a mist and/or foam is provided. The apparatus comprises at least one first fluid supply passage having an inlet in fluid communication with a first fluid supply and a first fluid outlet; at least one second fluid supply passage having an inlet in fluid communication with to second fluid supply and a second fluid outlet; and a nozzle in fluid communication with the first and second fluid outlets, the nozzle having a nozzle inlet, a nozzle outlet, and nozzle throat intermediate the nozzle inlet and the nozzle outlet, the nozzle throat having a cross sectional area which is less than that of both the nozzle inlet and the nozzle outlet; and wherein the second fluid outlet includes it porous member through which the second fluid must flow.

The present invention is directed to an apparatus for generating mists and/or foams from two fluids.

Apparatus which generate mists due to the interaction of two fluids within the apparatus are often referred to as “twin fluid atomisers”. In many cases, these atomisers utilise very small diameter passageways and channels for the fluids to pass through. These passageways and channels necessitate extremely high levels of accuracy when machining parts and/or assembling a number of parts together. It is therefore possible that inaccurate machining or assembly will have a detrimental effect on the efficiency and performance of the atomiser.

In addition, when seeking to generate small droplets in mist generation applications many existing twin fluid atomisers generate high levels of shear and turbulence in the interaction between the two fluids so as to achieve the desired degree of atomisation. Whilst this is desirable in mist-generating applications, these high levels of shear and turbulence are undesirable in foam-generating applications as they can inhibit the creation of bubbles in the foam. Consequently, existing mist-generating apparatus must be replaced by a foaming nozzle when it is necessary to switch from mist generation to foam generation in, for example, a fire suppression application.

It is an aim of the present invention to obviate or mitigate one or more of the aforementioned disadvantages.

According to the present invention, there is provided an apparatus for generating a mist and/or foam, the apparatus comprising:
at least one first fluid supply passage having an inlet in fluid communication with a first fluid supply and a first fluid outlet;
at least one second fluid supply passage having an inlet in fluid communication with a second fluid supply and a second fluid outlet; and
a nozzle in fluid communication with the first and second fluid outlets, the nozzle having a nozzle inlet, a nozzle outlet, and a nozzle throat intermediate the nozzle inlet and nozzle outlet, the nozzle throat having a cross sectional area which is less than that of both the nozzle inlet and nozzle outlet;
and wherein the second fluid outlet includes a porous member through which the second fluid must flow.

A “porous member” is a member which permits the movement of fluids through it by way of pores.

The nozzle may be downstream of the first and second fluid outlets, wherein the first and second fluid outlets are in fluid communication with the nozzle inlet.

The apparatus may further comprise a mixing chamber intermediate the first and second fluid outlets and the nozzle inlet.

The porous member may be hollow and surround the second fluid outlet so as to define an inner chamber at least partially located within the mixing chamber. The porous member may be adapted to permit movement of the second fluid through it in a radial direction only. In other words, axial movement of the second fluid through the porous member may be prevented.

The apparatus may comprise a plurality of first fluid supply passages having respective first fluid outlets, the first fluid outlets being circumferentially spaced about the second fluid outlet.

Alternatively, the first fluid outlet may be in fluid communication with the nozzle inlet, whilst the second fluid outer may open into the nozzle throat.

The apparatus may further comprise at least one nozzle extension having an extension passage with a first end connectable to the nozzle outlet and a second end remote from the nozzle outlet, wherein the first end of the extension passage has a cross sectional area substantially the same as that of the nozzle outlet, and wherein the cross sectional area of the extension passage increases between the first and second ends thereof. The increase in the cross sectional area of the extension passage may be linear.

According to a second aspect of the invention, there is provided a method of generating a mist and/or foam, the method comprising the steps of:
supplying pressurised first and second fluids into respective first and second fluid passages of a mist/foam generating apparatus, the second fluid passage including a second fluid outlet having a porous member therein;
directing the first fluid from the first fluid passage into a nozzle having a nozzle inlet, a nozzle outlet, and a nozzle throat whose cross sectional area is less than that of both the nozzle inlet and nozzle outlet;
directing the second fluid from the second fluid passage through the porous member and into the nozzle to mix with the first fluid;
accelerating the first and second fluids through the nozzle throat;
and spraying the first and second fluids from the nozzle outlet.

The first fluid may be a gas. The gas may be selected from the group comprising compressed air, carbon dioxide and nitrogen. The second fluid may be a liquid. The liquid may be selected from the group comprising water, a liquid decontaminant and a liquid fire suppressant.

The nozzle may be downstream of the outlets of both the first and second fluid passages, wherein the directing steps direct the first and second fluids into the nozzle inlet.

Alternatively, the second fluid passage may open into the nozzle throat, wherein the first fluid may be directed from the first fluid passage into the nozzle inlet, whilst the second fluid is directed into the nozzle throat.

The first and second fluids may be accelerated to at least sonic velocity through the nozzle throat.

Alternatively, the first fluid may be a liquid foam solution, and the second fluid may be compressed air or carbon dioxide. The foam solution may be a fire-fighting foam solution, and most preferably may be an aqueous film-forming foam solution.

The method may further comprise the step of passing the first and second fluids from the nozzle outlet through a nozzle extension passage connected to the nozzle outlet, the nozzle extension passage having a cross sectional area which increases from a first end connected to the nozzle outlet to a second end remote from the nozzle outlet.

Alternatively, the method may further comprise the step of passing the first and second fluids from the nozzle outlet through a nozzle extension passage connected to the nozzle outlet, the nozzle extension passage having an extension throat whose cross sectional area is less than that of both first and second ends of the extension passage.

Preferred embodiments of the present invention will now be described, by way of example only, with reference to the accompanying drawings. The drawings show the following:

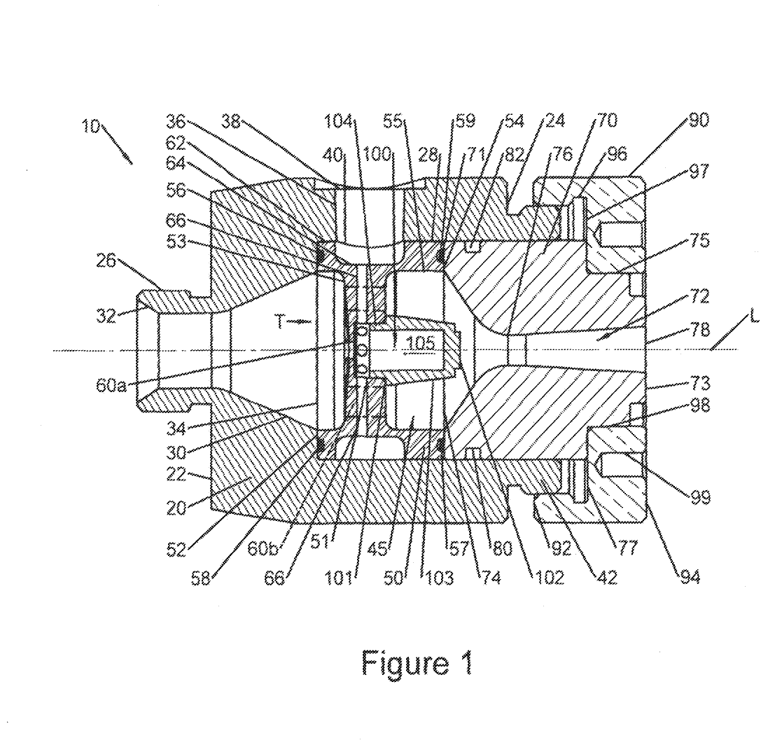

FIG. 1 is a longitudinal section through a first embodiment of an apparatus for generating a mist and/or foam;

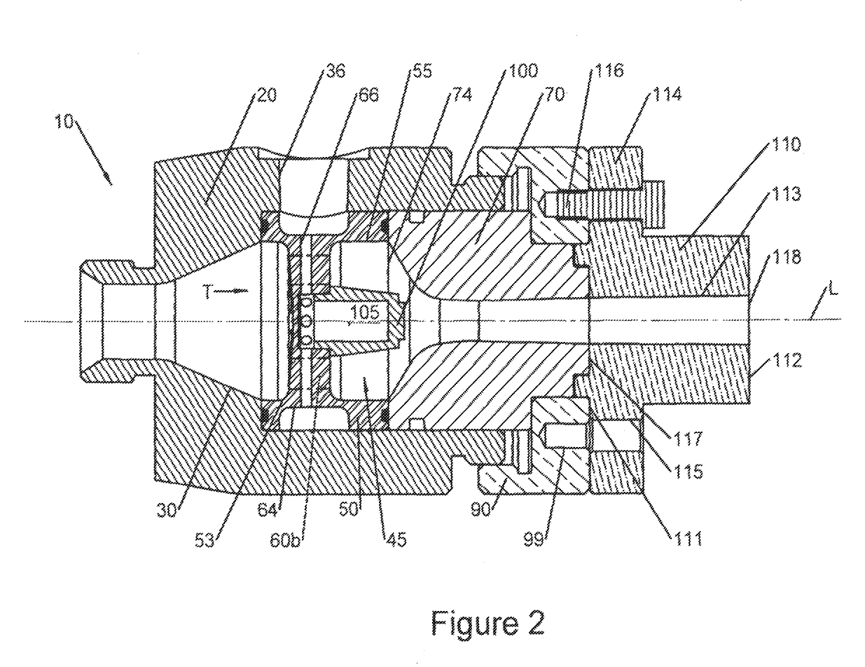

FIG. 2 is a longitudinal section through a modified version of the embodiment of FIG. 1;

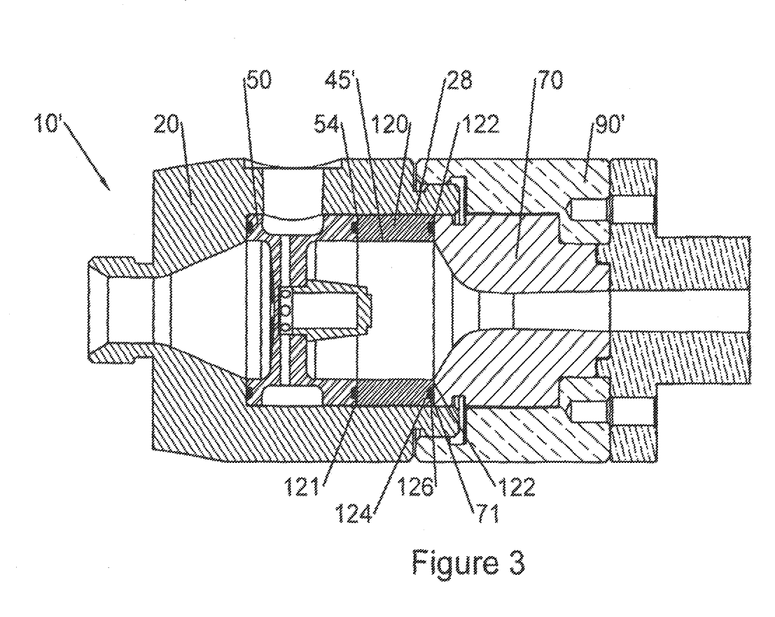

FIG. 3 is a longitudinal sect :on through a second embodiment of an apparatus for generating a mist and/or foam;

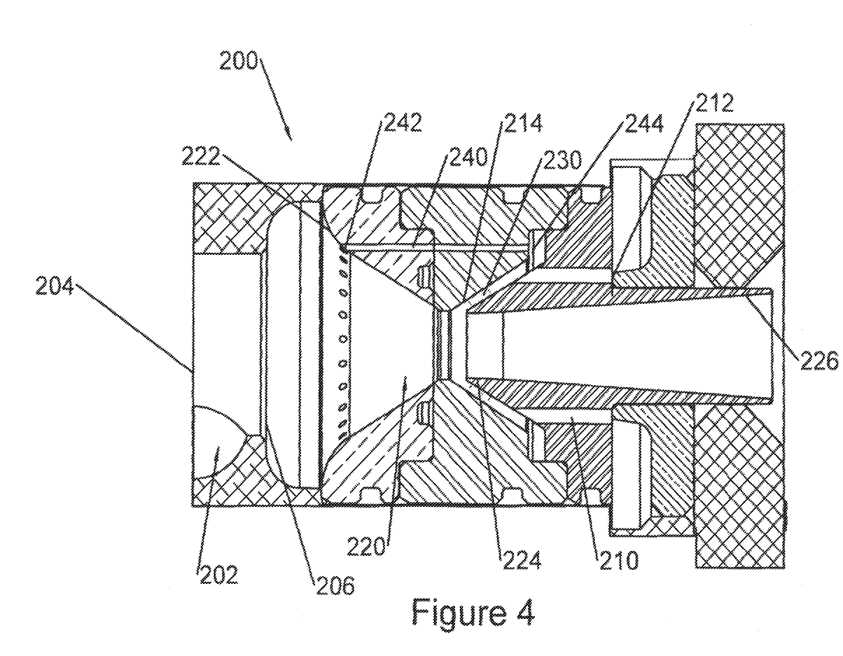

FIG. 4 is a longitudinal section through a third embodiment of an apparatus for generating a mist and/or foam; and

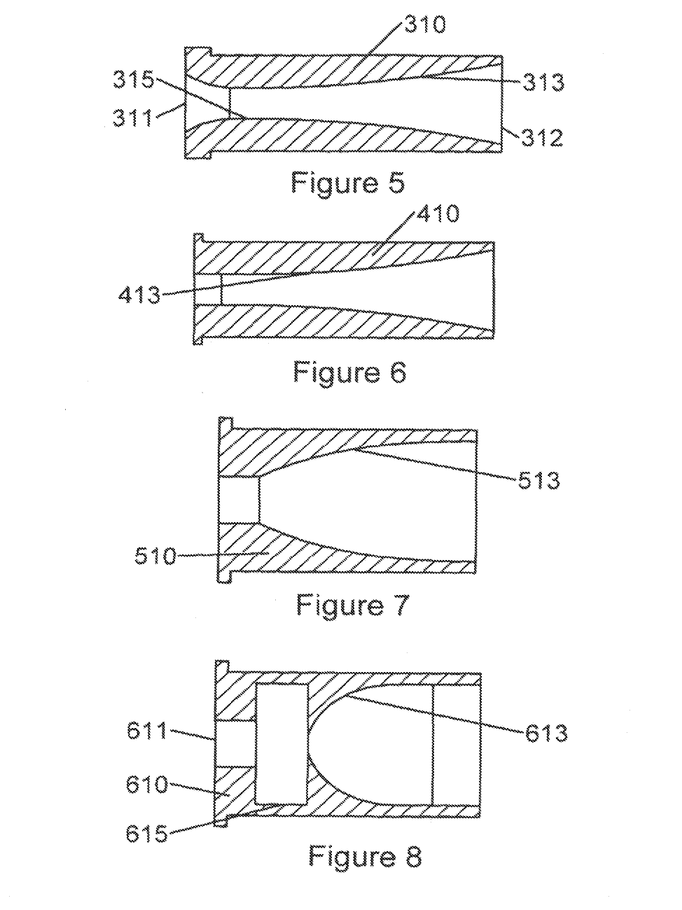

FIGS. 5 to 8 are longitudinal sections through alternative embodiments of nozzle extension which may form part of the present invention.

A first embodiment of an apparatus for generating a mist and/or foam, generally designated 10, is shown in FIG. 1. The apparatus 10 is made up of four main components: a generally cylindrical body or housing 20, a fluid distribution insert 50, a nozzle insert 70, and a locking ring 90.

The housing 20 has first and second ends 2224. A neck portion 26 projects axially from the first end 22 of the body 20. At the second end 24 of the body is a chamber 28 which is open at the second end 24 of the body 20 and adapted to receive the fluid distribution and nozzle inserts 50,70, as will be described below. Extending longitudinally through the body 20 is a first fluid supply conduit 30. The first fluid supply conduit 30 has an inlet 32 in the neck portion 26, and an outlet 34 which opens into the chamber 28. The first fluid supply conduit 30 has a diverging profile, where the cross sectional area of the conduit 30 increases as it extends through the body 20 from the inlet 32 towards the outlet 34. A second fluid supply conduit 36 is also provided in the body 20 and extends radially through a side wall of the body 20. The second fluid supply conduit 36 has an inlet 38 on the exterior of the body 20 and an outlet 40 which opens into the chamber 28. The first and second fluid supply conduits 30,36 are substantially perpendicular to one another. The neck portion 26 and/or the inlet 32 are connectable to a source of a first fluid (not shown), while the second fluid inlet 38 is connectable to a source of second fluid (not shown). The second end 24 of the body 20 has an axially projecting lip portion 42 of reduced outer diameter in comparison to the remainder of the body 20. At least a part of the outer surface of the lip portion 42 is provided with a thread (not shown).

The first insert 50 is a generally cylindrical insert which is generally I-shaped when viewed in a longitudinal section, as seen in FIG. 1, in other words, the first insert 50 is thickest at its outer periphery with the central portion of the insert 50 having a reduced thickness by comparison. The insert 50 has a first end face 52 and a second end face 54, each of which has an annular groove 56,57 extending about the circumference of the outer periphery of the insert 50. Located in each of the annular grooves 56,57 is an O-ring seal 58,59.

Because the insert 50 has an I-shape when viewed in a longitudinal section, the first and second end faces 52,54 of the insert 50 have respective first and second concave ca ties 53,55 formed therein. Extending longitudinally through the insert 50 and fluidly connecting the first and second cavities 53,55 are a plurality of first fluid passages 60b. The first passages 60b are circumferentially spaced about, and substantially parallel with a longitudinal axis L shared by the insert 50 and the assembled apparatus 10. Optionally, the first fluid passages 60b may be outer first fluid passages and the insert 50 may also include an inner first passage 60a located the centre of the insert 50 such that it is co-axial with the longitudinal axis L.

The insert 50 also has an outer circumferential surface 62 in which a channel 64 is formed. The channel 64 extends around the entire circumference of the insert 50. Extending radially inwards through the insert 50 from the channel 64 are a plurality of second fluid supply passages 66. The second passages 66 are substantially perpendicular to the first passages 60 and longitudinal axis L. The supply passages 66 extend radially inwards through the insert 50 in the circumferential spaces provided between the first passages 60b. The supply passages 66 allow fluid communication between the channel 64 and a third cavity 51 located at the centre of the insert 50.

The third cavity 51 is co-axial with the longitudinal axis L. The third cavity 51 is formed such that it is in fluid communication with each of the supply passages 66, the second cavity 55 and the optional inner first fluid passage 60a when present. The third cavity 51 has an internal thread as well as an internal diameter which is larger than that of the inner first passage 60a but smaller than that of the second cavity 55.

A generally cylindrical member 100 is provided for insertion into the third cavity 51 from the second cavity 55. The member 100 is porous whereby it permits the movement of fluids through it by way of pores. The member 100 may be formed from a porous metal or ceramic. Most preferably, the member 100 is formed from sintered bronze. The member 100 has a first end 101 and a second end 102. The first end 101 is open whilst the second end 102 is closed. The second end 102 is also preferably sealed so that fluid may not pass through the pores in the second end 102. The member 100 has an internal diameter which is substantially constant and an outer diameter which reduces from the first end 101 the direction of the second and 102. As a result, the outer surface 103 of the member 100 is frustoconical in shape. The first end 101 of the member 100 also has a lip portion 104 which extends axially away from the first end 101. The outer surface of the lip portion 104 is threaded so as to engage with the threaded third cavity 51. Thus, the first end 101 of the member 100 is attached to the first insert 50.

With the porous member 100 secured in the third cavity 51 the interior of the member 100 defines en inner chamber 105. The inner chamber 105 will receive second fluid from the second fluid passages 66 or, where the inner first fluid passage 60a is present, first and second fluids from the inner first fluid passage 60a and second fluid passages 66, respectively. The porosity of the member 100 allows the fluid(s) received in the inner chamber 105 to pass radially from the interior to the exterior of the member 100 and into an outer mixing chamber 45 partially defined by the second cavity 55.

The outer first fluid passages 60b are radially and circumferentially spaced so as to surround the optional inner first fluid passage 60a as well as the third cavity 51 and porous member 100. Where an inner first fluid passage is not required, the insert 50 can be formed without the inner first fluid passage, or else a plug (not shown) may be secured into the inner first fluid passage 60a to prevent any fluid entering or exiting the inner chamber 105 through the inner first fluid passage 60a.

As with the fluid distribution insert 50 the nozzle insert 70 is generally cylindrical and is co-axial with the remaining components of the apparatus 10. The second insert 70 has a nozzle 72 defined therein, the nozzle 72 having a nozzle inlet 74, a throat portion 76 and a nozzle outlet 78. The nozzle 72 is co-axial with the axis L, and the throat portion 76 intermediate the nozzle inlet 74 and nozzle outlet 78 has a cross sectional area which is less than that of both the nozzle inlet 74 and the nozzle outlet 78. It can also be seen that the reduction and subsequent increase in cross sectional area through the nozzle 72 is gradual. In other words, there are no step changes in cross sectional area which would create steps or niches in the nozzle wall which would interfere with the fluid flow therethrough. The nozzle 72 is therefore a “convergent-divergent nozzle” as is understood in the art.

The nozzle insert 70 has first and second ends having a first end face 71 and a second end face 73, respectively. A groove 80 is located in the outer circumferential surface of the insert 70 adjacent the first end. The groove 80 extends around the entire circumference of the insert 70 and an O-ring seal 82 is located in the groove 80. The nozzle insert 70 has a reduced diameter portion 75 adjacent the second end. The variation between the outer diameter of the main section of the insert 70 and that of the reduced diameter portion 75 creates an abutment face 77 which faces in the direction of the second and 73 of the insert 70.

The final component of the basic apparatus 10 is a locking ring 90, which has a first side face 92 and a second side face 94. The locking ring 90 has a bore passing through it which is divided into first and second portions 96,98. The first bore portion 96 opens on the first side face 92 whilst the second bore portion 98 opens on the second side face 94. The first bore portion 96 has a greater diameter than the second bore portion 98. The variation In diameter between the first and second bore portions 96,98 creates an abutment face 97, which faces in the direction of the first side face 92 of the locking ring 90. At least a part of the internal surface of the first bore portion 96 is provided with a thread (not shown). The second end 94 of the locking ring 90 is provided with one or more threaded apertures 99 which receive mechanical fixtures for securing additional components to the basic apparatus 10, as with be discussed further below.

When assembling the apparatus 10, the porous member 100 is screwed into the third cavity 51 of the fluid distribution insert 50 as described above. The insert 50 is then slid into the chamber 28 via the second end 24 of the body 20. The internal diameter of the chamber 28 and the external diameter of the insert 50 are such that a close, sealing fit is achieved between the insert 50 and the body 20. When the insert 50 is correctly positioned within the chamber 28, the first end face 52 of the insert abuts the outlet 34 of the first fluid supply conduit 30 in the body 20. As a result, the outlet 34 of the first fluid supply conduit 30 is in fluid communication with the first cavity 53 of the insert 50, and the second fluid supply conduit 36 is in fluid communication with the channel 64 of the insert 50. The O-ring seal 58 provides a sealing fit between the first insert 50 and the body 20.

Once the first insert 50 is in position, the nozzle insert 70 can be inserted into the chamber 28 via the second end 24 of the body 20. As with the first insert 50, the internal diameter of the chamber 28 and the external diameter of the second insert 70 are such that a close, sealing fit is achieved between the insert 70 and the body 20. When the second insert 70 is correctly positioned within the chamber 28, the first end face 71 or the second insert 70 abuts the second end face 54 of the first insert 50.

As a result, an outer mixing chamber 45 sharing the longitudinal axis L is defined by the nozzle inlet 74 of the second insert 70 and the second cavity 55 of the first insert 50. The porous member 100 and inner chamber 105 defined therein lie at least partially within the outer mixing chamber 45.

Following assembly, the body 20, first insert 50 and second insert 70 are now all in fluid communication with one another via the previously described cavities, passages and conduits defined within these components, as will be described in further detail below. The second of the O-ring seals 59 iodated in the second end face 54 of the first insert 50 provides a sealing fit between the first and second inserts 50,70.

Finally, once the first and second inserts 50,70 are located in their correct positions in the chamber 28 of the body 20, the looking ring 90 can be placed over the second end of the second insert 70. The threaded portions of the lip 42 of the body 20 and the first side face 92 of the locking ring 90 cooperate with one another so that the locking ring 90 can be screwed onto the body 20 until the respective abutment faces 77,97 of the second insert 70 and the locking ring 90 some up against one another. Once this has taken place, the first and second inserts 50,70 are firmly held in position, sandwiched between the body 20 and the locking ring 90.

The manner in which the apparatus 10 operates when generating a mist will now be described, again with reference to FIG. 1. In this preferred embodiment the inner first fluid passage 60a is plugged so that none of the first fluid may flow into this passage. It will be appreciated that the inner passage 60a should be open if a degree of pre-mixing of the first and second fluids is desired, but the method of mist generation described here does not require such pre-mixing and so the inner passage 60a is closed in the method of operation described below.

Initially, a first fluid is introduced from a suitable source (e.g. a bottle of compressed gas) into the first fluid supply inlet 32. There are a variety of fluids which would be suitable for use as the first fluid, but in this preferred example the, first fluid is compressed air. The supply pressure of the first fluid may be in the range 2 to 40 bar, or more preferably in the range 5 to 20 bar. The first fluid passes the first fluid supply conduit 30 in the direction of the arrow T into the first cavity 53 defined in the first insert 50. Once in the first cavity 53, the first fluid separates into a number of flew paths as it enters the outer first fluid passages 60b provided in the first insert 50. The first fluid flowing through the outer first fluid passages 60b enters the outer mixing chamber 45 defined between the second cavity 55 of the first insert 50 and the nozzle inlet 74 of the second insert 70. The first fluid flows exiting the outer fluid passages 60b expand and come into contact with one another in the outer mixing chamber 45, thereby creating a turbulent zone in the outer mixing chamber 45. The first fluid enters the outer mixing chamber 45 under high pressure but with a relatively low velocity.

At the same time as the first fluid is being introduced into the first fluid supply conduit 30, a second fluid is being introduced from a suitable source at a preferred supply pressure in the range 2 to 40 bar, most preferably in the range 5 to 20 bar. The second fluid is introduced into the second fluid supply conduit 33 provided in the body 20. As with the first fluid, the second fluid can be a number of fluids but in this preferred example is water. As the second fluid passes through the second fluid supply conduit 36, it enters the channel 642 provided in the exterior of the first insert 50. The second fluid can then flow around the entire circumference of the first insert 50 via the channel 64, which lies between the body 20 and the first insert 50. As it flows around the channel 64, the second fluid enters the plurality of radial supply passages 66 in the first insert 50 and flows inwards towards the longitudinal axis L of the apparatus. At the inner ends of the supply passages 66, the second fluid enters the inner chamber 105 defined Within the porous member 100.

The first and second fluids can be supplied over a large range of mess flow rates. The ratio between the mass flow rates of first and second fluid may vary over a preferred range from 20:1 to 1:10.

Once in the inner chamber 105, the second fluid will begin to seep through the porous member 100 into the outer mixing chamber 45. The degree of porosity and/or size of the pores in the material from which the member 100 is formed, as well as operating conditions such as, for example, the pressure difference across the porous member 100 between the inner chamber 105 and the mixing chamber 45, dictates the rate at which the second fluid enters the mixing chamber 45. Furthermore, forcing the second fluid through the pores of the member 100 creates extremely small droplets of the second fluid such that the second fluid is at least partially atomised upon entry into the mixing chamber 45. As the droplets of the second fluid come into contact with the first fluid streams in the mixing chamber 45, frictional forces and turbulent mixing between the two fluids leads to the further atomisation of the second fluid droplets. The turbulence generated by the first fluid entering the mixing chamber 45 further ensures that the droplets created by this atomisation of the second fluid are spread throughout the mixing chamber 45. This is the first stage of the mist generation mechanism employed by the present invention.

The remaining stages of the atomisation mechanism occur in the nozzle 72 of the apparatus 10. The second fluid droplets in the mixing chamber are carried by the turbulent first fluid into the nozzle inlet 74. The gradual reduction in cross sectional area between the nozzle inlet 74 and the nozzle throat 76 leads to an acceleration of the first fluid to a very high, preferably sonic, velocity at the point in the throat 76 with the smallest cross sectional area. This acceleration of the first fluid means that there is a velocity gradient across the droplets of second fluid in the convergent region of the nozzle (ie. the region between the nozzle inlet and the nozzle throat), as the portion of each droplet closest to the nozzle throat will be travelling faster than the portion closest to the nozzle inlet. This subjects the second fluid droplets to shear forces and leads to them stretching or elongating in the direction of flow. When the shear forces exceed the surface tension forces a further atomisation occurs as the droplets deform and break up into even smaller droplets. This shearing action is the second stage of the atomisation mechanism.

The reduced size second fluid droplets leave the nozzle throat 76 at very high, and preferably sonic, velocity. As previously described, the nozzle outlet 78 has a greater cross sectional area than the nozzle throat 76. Consequently, the high velocity first fluid undergoes an expansion as it flows from the throat portion 7c towards the outlet 78. This stretches the second fluid droplets contained in the first fluid and causes them to break up into a number of yet smaller second fluid droplets. This tearing of the droplets is the third stage in the atomisation mechanism employed by the present invention.

Finally, the droplets are sprayed from the nozzle outlet 78 as a mist comprising a dispersed phase of second fluid droplets in a continuous phase of the first fluid. Depending on the operating conditions, the flow through the nozzle 72 may be subsonic in the region between the throat portion 76 and the nozzle outlet 78. Alternatively, the operating conditions may mean that the flow in this region may be supersonic along some or all of its length, with the supersonic region terminating in a shock wave either between the throat portion 76 and the nozzle outlet 78, at the nozzle outlet 78, or external to the apparatus 10. In those operating conditions at which a shock wave occurs, it may provide a fourth droplet breakup mechanism due to the sudden pressure rise across the shockwave. Further droplet break-up may occur downstream of the nozzle exit, due to the high degree of turbulence generated in the flow as well as due to the interaction with the environment outside of the nozzle exit.

The basic apparatus described above is intended primary for mist generation. A modified version of that first embodiment of the apparatus 10 is shown in FIG. 2, and this is intended primarily for foam generation. The basic apparatus 10 is the same as that described above with reference to FIG. 1, and so each of the features described with respect to FIG. 1 shares the same reference number in FIG. 2. Those shared features will not be described again in full with reference to FIG. 2.

Where the modified apparatus 10 differs from FIG. 1 is that it includes a nozzle extension 110. The extension 110 is a generally cylindrical member with a first end 111, a second end 112, and an extension passage 113 extending longitudinally through the extension 110 from the first end 111 to the second end 112. The first end 111 is provided with a radially extending flange 114 through which are a number of axially extending apertures 115. The apertures 115 are aligned with the corresponding apertures 99 in the locking ring 90, and mechanical fixtures 116 are inserted into the apertures 115,99 to secure the extension 110 to the locking ring 90 and the remainder of the apparatus 10.

With the extension 110 secured to the remainder of the apparatus 10, a first end 117 of the extension passage 113 is connected to the nozzle outlet 78. The cross sectional area of the first end 117 of the extension passage 113 is preferably identical to that of the nozzle outlet 78. A second end 118 of the extension passage 113 has a cross sectional area larger than that of the first end 117 of the passage 113. Thus, there is a gradual divergence in the extension passage 113 from the first end 117 to the second end 118, but the rate of divergence is relatively small. In a preferred embodiment, the rate of divergence may be a 0.5 mm increase in extension passage diameter for every 30 mm in passage length from the first end 117 to the second end 118.

The method of operation of the apparatus 10 in order to generate foam will now be described with reference to FIG. 2. Once again, inner first fluid passage 60a is blocked off. If the apparatus has been previously been operating in mist-generation mode prior to the addition of the nozzle extension 110, the first and second fluid supplies are disconnected from their respective first and second fluid conduits 30,36. The first fluid is then re-connected to the apparatus 10 via the second fluid Supply conduit 36. As a result, the compressed air or other suitable fluid will now enter the apparatus via the second fluid supply passages 66. A second fluid supply is then connected to the first fluid supply conduit 30. In this foam-generating mode, a suitable second fluid for the task is a foam solution such as, for example, an aqueous film-forming foam (AFFF) solution for use in firefighting.

The supply pressure of the second, foam-forming fluid may be in the range 5 to 20 bar. The second fluid passes along the first fluid supply conduit 30 in the direction of the arrow T into the first cavity 53 defined in the first insert 50. Once in the first cavity 53, the second fluid separates into a number of flow paths as it enters the outer first fluid passages 60b provided in the first insert 50. The second fluid flowing through the outer first fluid passages 60b enters the outer mixing chamber 45 defined between the second cavity 55 of the first insert 50 and the nozzle inlet 74 of the second insert 70.

At the same time as the second fluid is being introduced into the first fluid supply conduit 30, the first fluid is being introduced from a suitable source at a preferred supply pressure in the range 2 to 40 bar, most preferably in the range 5 to 20 bar. The first fluid is introduced into the second fluid supply conduit 36 provided in the body 20. As the first fluid passes through the second fluid supply conduit 36, it enters the channel 64 provided in the exterior of the first insert 50. The first fluid can then flow around the entire circumference of the first insert 50 via the channel 64, which lies between the body 20 and the first insert 50. As it flows around the channel 64, the first fluid enters the plurality of radial supply passages 66 in the first insert 50 and flows inwards towards the longitudinal axis L of the apparatus. At the inner ends of the supply passages 66, the first fluid enters the inner chamber 105 defined within the porous member 100.

In this foam-generating embodiment the flow rate of the first fluid into the apparatus may be in the range 3 to 16 litres/min, whilst the mass flow rate of the second fluid may be in the range 0.5 to 2 kg/min. Most preferably, the flow rate of the first fluid into the apparatus may be in the range 3 to 13 litres/min whilst the mass flow rate of the second fluid is most preferably in the range 0.5 to 1.5 kg/min.

Once in the inner chamber 105, the gaseous first fluid will begin to seep through the porous member 100 into the outer mixing chamber 45. The degree of porosity and/or the size of the pores in the material from which the member 100 is formed, as well as operating conditions such as the pressure difference across the porous member 100 between the inner chamber 105 and the mixing chamber 45, dictates the rate at which the first fluid enters the mixing chamber 45. Furthermore, forcing the first fluid through the pores of the member 100 creates small bubbles of the first fluid which enter the mixing chamber 45 and the second fluid located therein.

The first fluid bubbles are earned by the second fluid from the mixing chamber 45 into the nozzle inlet 74. The gradual reduction in cross sectional area between the nozzle inlet 74 and the nozzle throat 76 leads to an acceleration of the second fluid. This acceleration of the second fluid and its passing through the nozzle throat 76 changes the pressure on the first fluid bubbles in the second fluid. Consequently, once the first and second fluid mixture has passed through the throat 76 the first fluid bubbles begin to expand as the fluid flow leads towards the nozzle outlet 78. The nozzle extension 110 and the gradually diverging passage 113. therein ensure that the first fluid bubbles expand gradually over the length of the passage 113, thereby creating larger bubbles and greater amounts of foam as a result once the fluids exit the apparatus 10.

A second embodiment of an apparatus for generating a mist and/or foam, generally designated 10′, is shown in FIG. 3. The second embodiment shares a number of components and features with both the basic and modified versions of the first embodiment shown in FIGS. 1 and 2. Consequently, features which are the same in each embodiment share the same reference numerals in this second embodiment and will not be described in detail again here.

In the second embodiment of the apparatus 10, a third insert 120 is inserted into the compartment 28 after the insertion of the first insert 50, but before insertion of the second insert 70. The third insert 120 is tubular and has an outer diameter which is selected so as to provide a close, sealing fit between the outer surface, of the third insert 120 and the inner surface of the compartment 28. To assist with the sealing fit, the end 122 of the third insert 120 adjacent the second insert 70 is provided with a circumferential groove 124 in which an O-ring seal 126 is iodated. Thus, when the third insert 120 is correctly positioned in the compartment 28, one end 121 of the insert 120 abuts the second end 54 of the first insert 50, whilst the other end 122 of the insert 120 will abut against the first end 71 of the second insert 70.

Certain modifications may be made to the body 20 in order to incorporate the third insert 120. For example, the axial length of the body 20 and compartment 28 may be increased so that all three inserts 50,70,120 can be located therein. Alternatively, as shown in FIG. 3, the axial length of the locking ring 90′ may be increased in order to accommodate the majority of the nozzle insert 70 protruding from the compartment 28. Alternatively, an additional outer section (not shown) may be added between the body 20 and the locking ring 90 and connected in an appropriate manner so as to surround the third insert 120. The nozzle extension 110 is present in the second embodiment as it is shown in foam-generation mode, but the second embodiment may be used without the extension in mist-generation mode as required.

Other than inserting the third insert 120, the second embodiment of the apparatus 10′ assembled and operates in substantially the same manner as the first embodiment. However, the presence of the tubular third insert 120 between the first and second inserts 50,70 increases the axial length of the mixing chamber 45 downstream of the -first insert 50. Changing the axial length of the mixing chamber 45′ assists in the development of foam bubbles in foam-generation mode and, when in mist-generation mode, alters the turbulence level and degree of swirl and mixing in the mixing chamber 45′ and alters the first stage of the atomisation mechanism employed during mist generation.

FIG. 4 shows a third embodiment of an apparatus for generating a mist and/or foam, generally designated 200. This third embodiment of the apparatus 200 comprises a first fluid supply passage 202 having an inlet 204 in fluid communication with a first fluid supply (not shown) and a first fluid outlet 206. The apparatus 200 also includes an annular second fluid supply passage 210 having an inlet 212 in fluid communication with a second fluid supply (not shown) and a second fluid outlet 214. A nozzle 220 is in fluid communication with the first and second fluid outlets 206,214 and has a nozzle inlet 222, a nozzle outlet 226, and a nozzle throat 224 intermediate the nozzle inlet 222 and nozzle outlet 226. The nozzle throat 224 has a cross sectional area which is less than that of both the nozzle inlet 222 and nozzle outlet 226. A porous ring member 230 is located in the second fluid outlet 214 such that any fluid flowing through the second fluid passage 210 must flow through the porous member 230. The first fluid outlet 206 communicates with the nozzle inlet 222, whilst the second fluid outlet 214 opens into the nozzle throat 224.

The nozzle 220 may optionally include at least one auxiliary passage 240, having an auxiliary inlet 242 upstream of the nozzle throat 224 and an auxiliary outlet 244 opening into the second fluid passage 210. The auxiliary passage 240 may be a single, annular passage surrounding the nozzle 220 or, as shown in FIG. 4, there may be a plurality of auxiliary passages 240 circumferentially spaced about the nozzle 220 and parallel thereto. The porous member 230 may be positioned in the second fluid passage 210 either upstream or downstream of where the auxiliary outlet(s) 244 opens into the second passage 210.

As seen in FIG. 4, the cross sectional area of the nozzle 220 gradually increases from the nozzle throat 224 in the direction of the nozzle outlet 226. The apparatus 200 can be supplemented with a nozzle extension of the kind described above so as to extend the diverging passage of the apparatus.

As with the previous embodiments, the third embodiment of the apparatus 200 can be used for mist generation and/or foam generation. In mist generation mode, a first fluid such as compressed air, carbon dioxide, steam or nitrogen is supplied to the first fluid passage 202. From there the pressurised first fluid enters the nozzle 220 and is accelerated through the nozzle throat 224 to a high, preferably sonic, velocity at the point in the throat having the smallest cross sectional area. At the same time, a second fluid such as water, a liquid decontaminant or fire suppressant supplied to the second fluid passage 210. The porous member 230 in the second fluid passage 210 regulates the flow of the second fluid into the nozzle throat 224 such that small droplets of the second fluid leave the porous member 230 and enter the nozzle 220. If present, the auxiliary passage(s) 240 diverts a portion of the first fluid into the second fluid passage 210, which has the effect of partially atomising the second fluid prior to its introduction into the nozzle 220.

As the second fluid droplets enter the accelerated stream of first fluid in the nozzle throat 224 they are subjected to high shear forces and turbulence from the first fluid, which further atomises the second fluid droplets breaking them into smaller droplets. A dispersed phase of second fluid droplets in a continuous phase of the first fluid then travels towards the nozzle outlet 226. As it does so, the droplets expand and again break into still smaller droplets before being sprayed from the apparatus as a mist.

For the third embodiment to operate in foam generation mode the first fluid supply is disconnected and reconnected to the second fluid passage 210, as with the other embodiments. A foam solution second fluid is then supplied tote first fluid passage 202. Bubbles of the first fluid then exit the porous member 230 in the second fluid passage 210 and enter the second fluid at the nozzle throat 224. The bubbles expand as the first and second fluids travel towards the nozzle outlet 226 and nozzle extension not shown) attached thereto in the same manner as described above with respect to the earlier embodiments. The first and second fluids then exit the apparatus as a foam.

By using a porous member, the apparatus of the present invention can introduce one fluid to another fluid at low flow rates and/or with a desired droplet or bubble size which would otherwise require the accurate and skilled machining of passageways of very small diameter. Thus, the present invention removes the possibility of inaccurate machining or manufacture affecting the performance of the apparatus.

The present invention also provides a sing e apparatus which can generate a mist of droplets in one mode, and generate a foam in a second mode. Usually two apparatus are required, as mist generation seeks to produce droplets which are as small as possible, but in foam generation it is desirable to produce bubbles which are as large as possible. The levels of shear and turbulence generated when atomising droplets in mist-generation mode are not conducive to the creation of large bubbles if the same apparatus is used for foam generation as well. However a simple switch of the gaseous fluid supply from the first supply conduit to the second supply conduit allow the apparatus of the present invention to also generate foam and mists, thanks to the bubbling of the gaseous first fluid through the porous member into the foam solution. The expansion of the bubbles in the foam solution is slowed due to the addition of the nozzle extension, so that the bubbles are as large as possible when they leave the apparatus.

Aside from a separate supply of foam solution, the nozzle extension is the only additional part required to convert the apparatus into foam generation mode. A number of alternative embodiments of nozzle extension are shown in FIGS. 5 to 8. FIG. 5 shows a first alternative extension 310 have an extension passage 313 with a throat 315 whose cross sectional area is less than that of both the first and second ends 311,312 of the extension passage 313. FIG. 6 shows a second alternative extension 410 in which an extension passage 413 has walls which taper or diverge smoothly in the downstream direction, such that the cross sectional area of the passage 413 gradually increases in the downstream direction along the passage 413. FIG. 7 shows a third alternative extension 510 in which the passage 513 has walls which have a relatively sudden outward taper or divergence to rapidly increase the cross sectional area of the downstream section of the passage 513. In the third alternative embodiment the rate of divergence or increase in cross sectional area gradually slows in the downstream direction until the passage 513 reaches its largest cross sectional area. Finally, a fourth alternative extension 610 is shown in FIG. 8. This embodiment is similar to that of the third alternative in that the rate of increase of cross sectional area in the passage 613 begins comparatively high but then gradually slows prior to the passage reaching its largest cross sectional area. Where the fourth embodiment differs is that the cross sectional area of the passage 613 adjacent the first end 611 abruptly increases and decreases to form a chamber 615 of greater cross sectional area than a first end 511 of the passage 615. Downstream of the chamber 615 is a diverging portion of the passage 613 similar to that shown in the third alternative embodiment.

The apparatus may also comprise a set of nozzle extensions, which may have different lengths and/or internal geometries of the kind described in the embodiments of extension described herein. Alternatively, differently shaped nozzle extensions could be attached to one another in series to further extend the gradually diverging passage.

The extension passage may have a ratio D:L, where D is the diameter of the first end of the extension passage and L is the linear length of the passage, selected from the group comprising 1:3, 1:4, 1:16: 1:20, 1:30, and 1:40.

Although the nozzle extension is preferably secured by mechanical fixtures as described above, other methods of attachment are envisaged. For example, the extension could be screwed onto the end of the nozzle by way of cooperating threaded portions. Additionally, the extending flange 114 may not be permanently attached, but may be quickly attached and removed using a quick release mechanism.

Whilst the ability of the apparatus to switch between mist- and foam-generation is advantageous, the apparatus of the present invention does not need to be employed for both functions. In other words, the apparatus and its porous member may be employed as a mist generation apparatus only, or as a foam generation apparatus only.

A number of porous members, each having a different porosity, may be provided with the apparatus so that the flow rate and/or droplet or bubble size of fluid from the inner chamber to the mixing chamber can be varied as desired. As stated, the porous member(s) may be formed from a porous metal (e.g. sintered bronze or brass) or a porous ceramic.

In mist generating mode, the first fluid may be compressed air, carbon dioxide or nitrogen, and the second fluid may be water, a liquid decontaminant or fire suppressant. In foam generating mode, the first fluid may be a foam solution, and the second fluid may be compressed air or carbon dioxide. The foam solution may be a fire-fighting foam solution, such as an aqueous film-forming foam solution, for example. Alternatively, the foam may be a coating for decontamination or a surface coating for cleansing purposes.

These and other modifications and improvements may be incorporated without departing from the scope of the present invention.

1. An apparatus for generating a mist and/or foam, the apparatus comprising:
at least one first fluid supply passage having an inlet in fluid communication with a first fluid supply and a first fluid outlet;
at least one second fluid supply passage having an inlet in fluid communication with a second fluid supply and a second fluid outlet; and
a nozzle in fluid communication with the first and second fluid outlets, the nozzle having a nozzle inlet, a nozzle outlet, and a nozzle throat intermediate the nozzle inlet and nozzle outlet, the nozzle throat having it cross sectional area which is less than that of both the nozzle inlet and nozzle outlet; and wherein the second fluid outlet includes a porous member through which the second fluid must flow.

2. The apparatus of claim 1, wherein the nozzle is downstream of the first and second fluid outlets, wherein the first and second fluid outlets are in fluid communication with the nozzle inlet.

3. The apparatus of claim 2, further comprising a mixing chamber intermediate the first and second fluid outlets and the nozzle inlet, and wherein the porous member is hollow and surrounds the second fluid outlet so as to define an inner chamber at least partially located within the mixing chamber.

4. The apparatus of claim 1, further comprising a plurality of first fluid supply passages having respective first fluid outlets, the first fluid outlets being circumferentially spaced about the second fluid outlet.

5. The apparatus of claim 1, wherein the first fluid outlet is in fluid communication with the nozzle inlet, whilst the second fluid outlet opens into the nozzle throat.

6. The apparatus of claim 1, further comprising at least one nozzle extension having an extension passage with a first end connectable to the nozzle outlet and a second end remote from the nozzle outlet, wherein the first end of the extension passage has a cross sectional area substantially the same as that of the nozzle outlet, and wherein the cross sectional area of the extension passage increases between the first and second ends thereof.

7. The apparatus of claim 6, wherein the increase in the cross sectional area of the extension passage is linear.

8. A method of generating a mist and/or foam, the method comprising the steps of:
supplying pressurised first and second fluids into respective first and second fluid passages of a mist/foam generating apparatus, the second fluid passage Including a second fluid outlet having a porous member therein;
directing the first fluid from the first fluid passage into a nozzle having a nozzle inlet, a nozzle outlet, and a nozzle throat whose cross sectional area is less than that of both the nozzle inlet and nozzle outlet;
directing the second fluid from the second fluid passage through the porous member and into the nozzle to mix with the first fluid;
accelerating the first and second fluids through the nozzle throat;
and spraying the first and second fluids from the nozzle outlet.

9. The method of claim 8, wherein the nozzle is downstream of the outlets of both the first and second fluid passages, and wherein the directing steps direct the first and second fluids into the nozzle inlet.

10. The method of claim 8, wherein the second fluid passage opens into the nozzle throat, wherein the first fluid may be directed from the first fluid passage into the nozzle inlet whilst the second fluid is directed into the nozzle throat.

11. The method of claim 8, wherein the first and second fluids are accelerated to at least some velocity through the nozzle throat.

12. The method of claim 8, wherein the first fluid is a gas selected from the group comprising compressed air, carbon dioxide. and nitrogen.

13. The method of claim 8, wherein the second fluid is a liquid selected from the group comprising water, a liquid decontaminant and a liquid fire suppressant.

14. The method of claim 8, wherein the first fluid is a liquid foam solution, and the second fluid is compressed air or carbon dioxide.

15. The method of claim 14, wherein the foam solution is an aqueous film-forming foam solution.

16. The method of claim 14, further comprising the step of passing the first and second fluids from the nozzle outlet through a nozzle extension passage connected to the nozzle outlet, the nozzle extension passage having a cross sectional area which increases from a first end connected to the nozzle outlet to a second end remote from the nozzle outlet.

17. The method of claim 14, further comprising the step of
passing the first and second fluids from the nozzle outlet through a nozzle extension passage connected to the nozzle outlet, the nozzle extension passage having an extension throat whose cross sectional area is less than that of both first and second ends of the extension passage.
